(19) United States
(12) Patent Application Publication
(10) Pub. No.: US 2002/0089527 A1
(43) Pub. Date: Jul. 11, 2002

(54) System and method for generating an MNP flowchart (multi-nodal-progression)

(76) Inventor: James I. Paradies, Clintondale, NY (US)

Correspondence Address: RICHARD L. CATANIA, ESQ., SCULLY, SCOTT, MURPHY AND PRESSER, 400 Garden City Plaza, Garden City, NY, 11530, US

(21) Appl. No.: 09/756,996

(22) Filed: Jan. 8, 2001

(51) Int. Cl. G06F 3/00; G06F 13/00

(52) U.S. Cl. 345/700; 345/765

(57) ABSTRACT

According to a preferred embodiment, there is provided an automatic flowcharting method for diagrammatically representing a multi-nodal process comprising processing operations and decision operations, the method comprising: converting processing operations and decision operations of the multi-nodal process into a data structure; analyzing the data structure for identifying a first group of processing operations that appear once in the data structure, and for identifying a second group of processing operations that are associated with two or more decision operations in the data structure; traversing said data structure to generate an ordered sequence of processing operations for visual representation; and generating a diagrammatic representation of the ordered sequence including orienting successive processing operations in a vertical dimension and associating attributes to each processing operation of the processing operations according to their identified group while offsetting each successive processing operation in a horizontal dimension, and linking each processing operation of the second group to a further processing step of the processing steps according to a decision operation of the two or more decision operations.

### BACKGROUND OF THE INVENTION

1. Technical Field of the Invention

The present invention generally relates to flowcharting, and more particularly to an automated real-time flowcharting technique for flowcharting multi-nodal processes or workflows from raw data, comprising linked process or workflow elements, for presentation over a communications network.

2. Description of the Prior Art

Flowcharting is one of the best techniques for diagrammatically or pictorially representing information about processes or workflows. A flowchart provides a means for conveying information about an existing or proposed process or workflow. The flowchart further provides a means for improving the process or the workflow. The flowchart conveys information by pictorially representing process steps or workflow activities involved in a particular process or workflow. Furthermore, the flowchart diagrammatically represents a flow of the steps or activities in the process or workflow. In order to be useful, the flowchart must be able to clearly and unambiguously communicate internal logic (i.e., flow of steps in a process or activities in a workflow) of the flowchart to a user, a team or an enterprise (e.g., organization). In order to achieve the foregoing requirement, the flowchart is generally constructed with relatively few easily recognizable symbols.

Improvement to pictorially representing information has come via the introduction of computer programs for creating flowcharts. Computer programs enable users to draw flowcharts comprising myriad symbols (e.g., described herein below), which represent internal logic of the flowchart. The programs further enable the users to easily and clearly draw the symbols and to neatly align them with connecting lines. Today, vendors of flowcharting programs (e.g. Visio© 5.0) face end-market pressures of developing flowcharting programs that are user-friendly (i.e., easy to use) while having a maximum number of features and attributes (e.g., symbol libraries and customizable symbols) to satisfy different users. Utilization of the myriad symbols blurs the unambiguous pictorial representation of the underlying process or workflow that a flowchart is intended to represent and hence such a flowchart is often undesirable.

The International Standards Organization (“ISO”), which is an international organization for standardization that represents an international consensus on the state of the art in a particular technology, has provided guidelines for quality management and assurance standards within an organization using tools and techniques based on data collection and analysis. The ISO has described a flowchart as a pictorial representation of the steps in a process, which is useful for investigating opportunities for improvement by gaining a detailed understanding of how the process actually works. The ISO further stated that flowcharts are constructed with easily recognized symbols and has provided standard symbols for generating flowcharts. FIG. 1 particularly illustrates this standard 100, which implements just four symbols including: 1) a begin/end symbol 102 for depicting a “begin” and an “end” for a process or workflow; 2) a processing symbol 104 for depicting a processing of an activity in the workflow or a step in the process; 3) a decision symbol 106 for depicting a decision as to which further step in the process or activity in the workflow is to be performed; and 4) a flow connector symbol 108 for interconnecting and directing flow between symbols 102, 104 and 106. Additional symbols that are standard in flowcharting, but which are not described by the ISO, are 5) an input/output symbol 110 for diagramming entry or display of information; and 6) an enter/exit connector 112 for connecting remote portions of a flowchart.

With the aforementioned few standard symbols, a simple process or workflow can be unambiguously represented in a flowchart, to clearly communicate internal logic (i.e., flow of steps in a process or activities in a workflow) of the flowchart to a user, a team or an enterprise. In sharp contrast, a process or a workflow of only modest complexity requires a large quantity of symbols 104, 106, 110 and flow connectors 108 and 112, and can require many user-defined symbols and connectors. For example, if a single flowchart were to be drawn depicting a complex process or workflow, it's tremendous size—both visually (i.e., on multiple document pages) and physically (i.e., in a computer storage)—would make the flowchart totally unmanageable. Furthermore, a vast majority of flowcharting programs in the marketplace provide the ability for creating flowcharts by utilizing a large quantity of pre-defined and user-defined symbols. Yet further, it is significant to note that the standard flowchart symbols 100 do not provide for a sub-process symbol, and the sub-process is only achieved by utilizing multiple symbols 104, 106, 110 and interconnecting them with symbols 108 and 112, or creating an unfamiliar symbol for the sub-process. Coupled together, these factors create confusion and lead to misinterpretations in a flowchart of only modest complexity. Inevitably, these factors lead to convoluted and misrepresented internal logic (i.e., flow of steps in a process or activities in a workflow to be represented in a flowchart) and can create confusion and misinterpretation in users that implement the flowchart.

Considering the foregoing, it is highly desirable provide a flowcharting technique for simplifying a view of any complex data that has linked data elements. It is further very desirable to provide a flowcharting technique for processing processes or workflows that are too large and complex for conventional flowcharting techniques and are constantly changing. Still further, it is highly desirable to provide a flowcharting technique that presents a sequence of processing operations clearly. Yet further it is very desirable to provide an automated flowcharting technique for processing processes or workflows, thereby eliminating a need for an employee dedicated to updating flowcharts of the processes or workflows.

As aforementioned, if a single flowchart were to be drawn depicting a complex process or workflow, it's tremendous size—both visually and physically—would make the flowchart totally unmanageable, particularly for presentation over an Intranet/Internet where bandwidth is at a premium. Because of bandwidth considerations for the Intranet/Internet, it is highly desirable to provide a flowcharting technique for processing processes or workflows for presentation over a communications network, such the Intranet/Internet. In light of this consideration, it is highly desirable to provide a flowcharting technique for processing processes or workflows for presentation over a communications network via a web-enabled browser, such as Netscape Communicator™ or Internet Explorer™. That is, it is highly desirable to provide a flowcharting technique for processing processes or workflows, which is capable of generating markup language flowcharts (e.g., HTML) for transmission over the communications network.

### SUMMARY OF THE INVENTION

It is an object of the present invention to provide an automated flowcharting technique for simplifying the view of any complex data that has linked data elements.

It is another object of the present invention to provide an automated flowcharting technique for diagrammatically representing process flows, which are constantly changing.

It is a further object of the present invention to provide an automated flowcharting technique for representing process flows that are too large and complex for conventional flowcharting techniques.

It is yet another object of the present invention to provide an automated flowcharting technique, which follows each possible path and presents the sequence of processing operations clearly.

It is an object of the present invention to provide an automated flowcharting technique for presenting diagrammatical representation of process flows over a communications network, such as an Intranet or the Internet.

It is still a further object of the present invention to provide an automated flowcharting technique for presenting diagrammatical representation of process flows over a communications network via a web-enabled browser (e.g., HTML-enabled browser), such as Netscape Communicator™ or Internet Explorer™.

It is still a further object of the present invention to provide an automated flowcharting technique for presenting a compact, yet easily visually discernable diagrammatical representation of process flows.

It still a further object of the present invention to provide an automated flowcharting technique for presenting diagrammatical representation of process flows, which eliminates a need for employees to manually update flowcharts of the process flows.

Thus, according to a preferred embodiment, there is provided an automatic flowcharting method for diagrammatically representing a multi-nodal process comprising processing operations and decision operations, the method comprising: converting processing operations and decision operations of the multi-nodal process into a data structure; analyzing the data structure for identifying a first group of processing operations that appear once in the data structure, and for identifying a second group of processing operations that are associated with two or more decision operations in the data structure; traversing said data structure to generate an ordered sequence of processing operations for visual representation; and generating a diagrammatic representation of the ordered sequence including orienting successive processing operations in a vertical dimension and associating attributes to each processing operation of the processing operations according to their identified group while offsetting each successive processing operation in a horizontal dimension, and linking each processing operation of the second group to a further processing step of the processing steps according to a decision operation of the two or more decision operations.

According to another aspect of the present invention, there is provided an automatic flowcharting system for diagrammatically representing a multi-nodal process comprising processing operations and decision operations in a client-server environment, the system comprising: (a) a server interconnected via a communications network to a client, the server including: (i) a mechanism for converting processing operations and decision operations of the multi-nodal process into a data structure; (ii) a mechanism for analyzing the data structure for identifying a first group of processing operations that appear once in the data structure, and for identifying a second group of processing operations that are associated with two or more decision operations in the data structure; (iii) a mechanism for traversing the data structure to generate and ordered sequence of processing operations for visual representation; (iv) a mechanism for generating a diagrammatic representation of the ordered sequence including orienting the processing operations in a vertical dimension and associating attributes to each processing operation of the processing operations according to their identified group while offsetting each successive processing operation in a horizontal dimension, and linking each processing operation of the second group to a further processing step of the processing steps according to a decision operation of the two or more decision operations; and (b) the client for receiving the generated diagrammatic representation of the multi-nodal process via the communications network in a form for presentation by the client.

According to yet another aspect of the present invention, there is provided a program storage device readable by a machine, tangibly embodying a program of instructions executable by the machine to perform an automatic flowcharting method for diagrammatically representing a multi-nodal process comprising processing operations and decision operations, the method comprising: converting processing operations and decision operations of the multi-modal process into a data structure; analyzing the data structure for identifying a first group of processing operations that appear once in the data structure, and for identifying a second group of processing operations that are associated with two or more decision operations in the data structure; traversing the data structure to generate an ordered sequence of processing operations for visual representation; and generating a diagrammatic representation of the ordered sequence including orienting the processing operations in a vertical dimension and associating attributes to each processing operation of the processing operations according to their identified group while offsetting each successive processing operation of the in a horizontal dimension, and linking each processing operation of the second group to a further processing operation of the processing operations according to a decision operation of the two or more decision operations.

### BRIEF DESCRIPTION OF THE DRAWINGS

Preferred embodiments of the present invention will now be described, by way of example only, with reference to the accompanying drawings:

FIG. 1 is an exemplary illustration of standard symbols utilized in accordance with prior art flowcharting techniques.

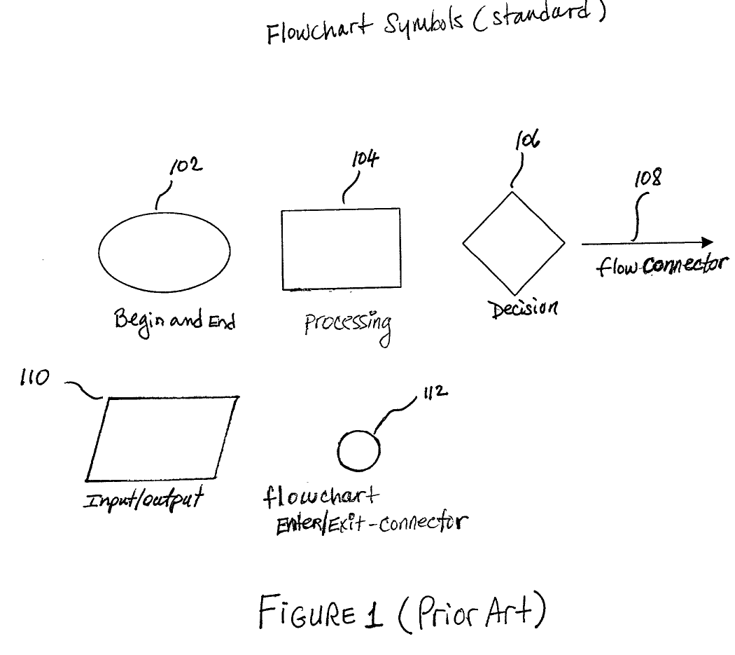

FIG. 2 is an exemplary illustration of input data for a multi-nodal (e.g., linked process or workflow elements) process or workflow in accordance with the present invention.

FIG. 3 is an exemplary illustration exemplifying a diagrammatical representation of the multi-nodal process illustrated in FIG. 2 in accordance with the present invention.

FIGS. 4 and 5 conjunctively illustrate a preferred way for determining the horizontal indentation and vertical alignment of the successive processing operations in accordance with the present invention.

FIG. 6 is an exemplary diagram representing a system in which the present invention can be practiced.

### DETAILED DESCRIPTION OF THE PREFERRED EMBODIMENTS OF THE INVENTION

The present invention is directed to an automated real-time flowcharting technique for flowcharting multi-nodal processes or workflows from raw data, comprising linked process or workflow elements, for presentation over a communication network. The present invention is embodied in a software program aimed at achieving the foregoing objects.

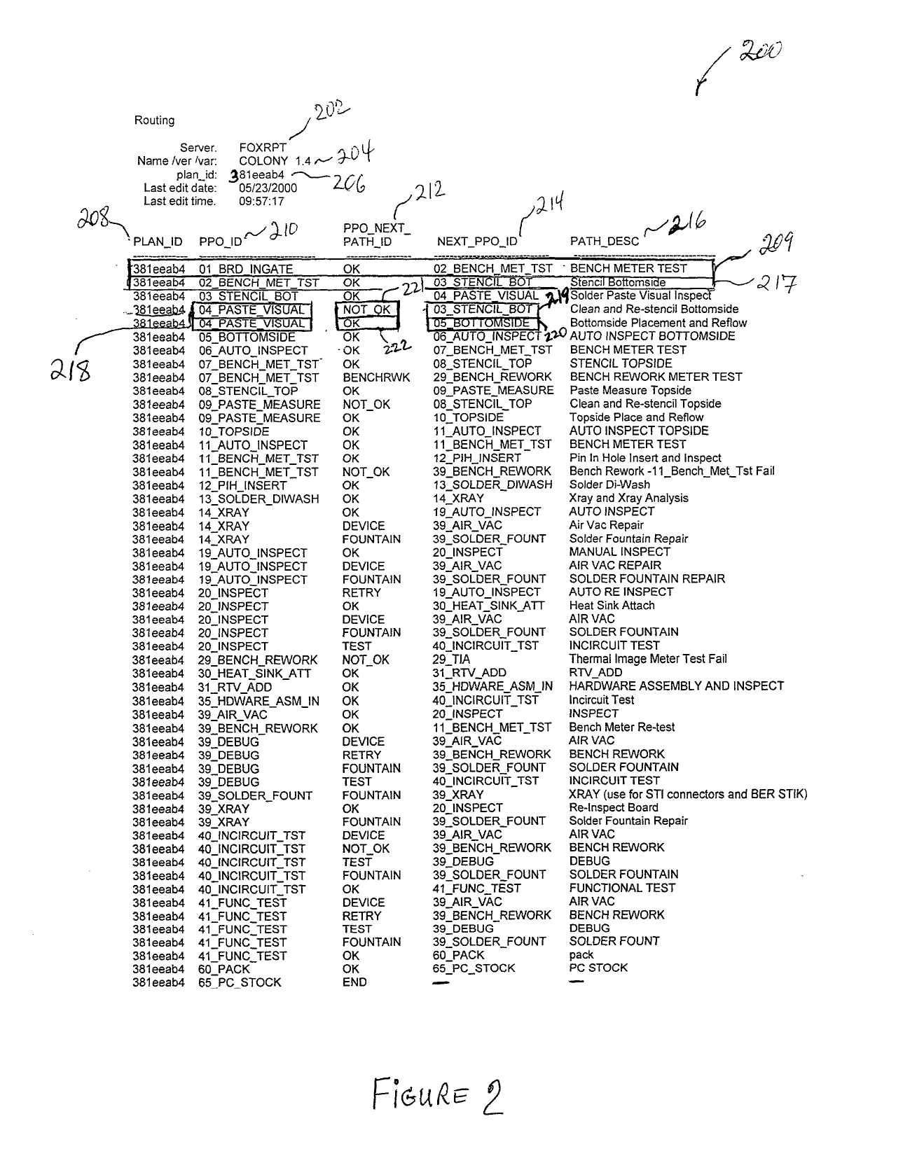

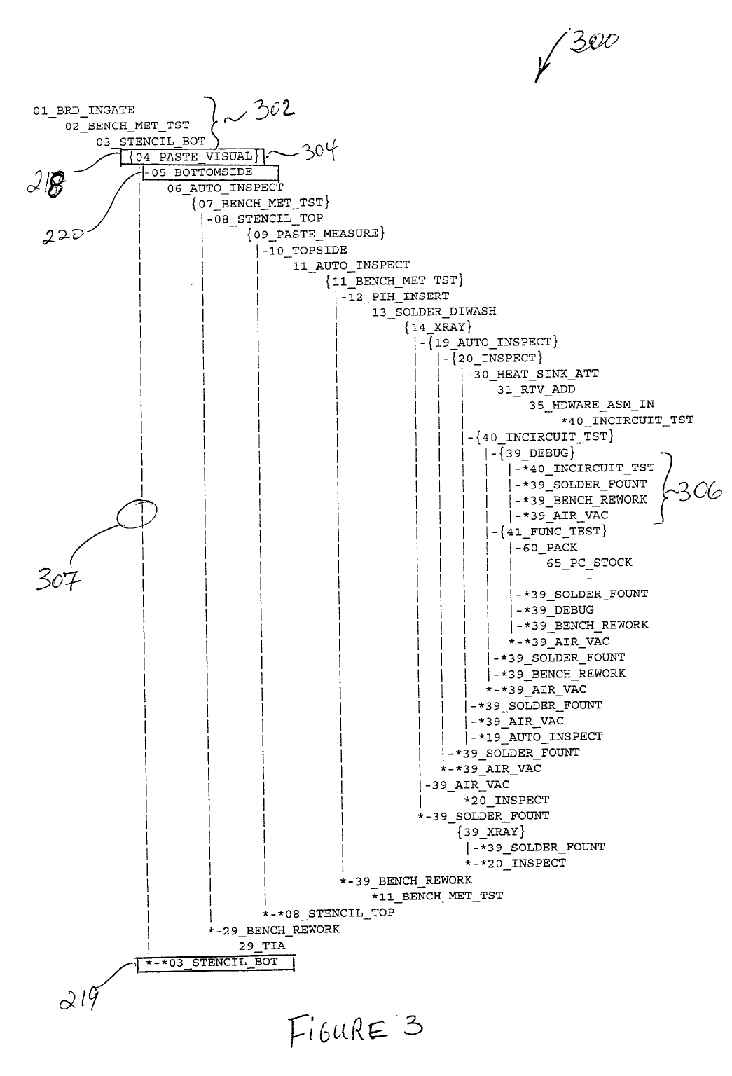

In the present invention, multi-nodal progression describes a way of viewing process steps or workflow activities (i.e., nodes) in routing a particular process or workflow. That is, each process step or workflow activity (i.e., node) is followed by another process step or workflow activity (i.e., node). For example, in manufacturing a product (e.g., FIG. 2), a sequence of steps or activities progresses from one node 218 to another node 220 and the like during a manufacturing process. Routing a product identifies and determines steps or activities and their ordered sequence with respect to one another—from the beginning to the end—necessary to complete the manufacturing of the product. Consequently, a multi-nodal-progression flowchart (e.g., FIG. 3) diagrammatically represents a progression of steps or activities involved in a product routing.

FIG. 2 represents an exemplary illustration of input raw data, which represents a routing for a multi-nodal (e.g., linked process or workflow elements) of an exemplary process or workflow 200, according to the present invention. As depicted in FIG. 2, the input raw data is stored on a server 202 in a file 204 having records 209, wherein the records 209 are identified by a plan_id 206. The raw data may be manually or automatically extracted or exported from a database on the server 202 into the file 204 based on the plan_id 206 or on any other unique key in a conventional manner. For example, a conventional batch file can be utilized to automatically export process or workflow records from a database into a file for further processing. Additionally, it is contemplated that the input raw data can be utilized directly from the database on the server 202 via conventional methods, without first exporting the data into the file 204. The structure of file 204 includes the following five columns: 1) PLAN_ID 208; 2) PPO_ID 210; 3) PPO_NEXT_PATH_ID 212; 4) NEXT_PPO_ID 214; and 5) PATH_DESC 216. The column PLAN_ID 208 includes records 209 with a unique plan_id 206 for routing the process or workflow. The column PPO_ID 210 and the column NEXT_PPO_ID 214 represent a plurality of processing operations involved in the routing. The column PPO_NEXT_PATH_ID 212 represents a plurality of decision operations for traversing the plurality of processing operations involved in the routing. For each record 209, the column PATH_DESC 216 represents a description of a path taken (i.e., next step or activity performed) in the column NEXT_PPO_ID 214 based on a decision operation in column PPO_NEXT_PATH_ID 212.

Execution of the program embodying the present invention is now described. First, the program is conventionally instantiated, e.g., by executing an executable file. An input filename representing a file containing input data of a multi-nodal process or workflow is passed into the program as a runtime parameter (e.g., FIG. 2, 204), and an output filename for a file to receive an output diagrammatic representation of the multi-nodal process or workflow is defined by the program or specified as a runtime parameter. As is understood by one skilled in the art, the program can be designed to accept any type of a file containing input data, such as a binary file, a text file and the like. At the time of program instantiation, the program embodying the present invention performs the following preliminary checks, and the program is aborted if any of the following checks fail. The program checks whether an input filename runtime parameter was passed in, whether a physical file represented by such runtime parameter exists, as well as whether the program can read data from the physical file. Other conventional error checking may also be performed according to known programming techniques.

Following the instantiation, the program reads the input file 204 containing the input data in a conventional manner, and converts a plurality of processing operations 210, 214 and a plurality of decisions operations 212 for the multi-nodal process into a data structure sufficient to hold such data. The data structure utilized to hold the processing operations and the decisions operations contained in the input file 204 is preferably an array of structures, which is defined in the following exemplary manner in the programming language C:

struct operation_structure {

int count;

char plan_id[50];

char ppo_id[50];

char path[50];

char next_ppo_id[50];

char path_desc[50];

}op_struct[100];

In the input file 204, the first record 209 represents a starting processing operation. As an exemplary illustration, a first element of the array contains the following data of the first record 209 from the input file 204:

int iCount=1; /*temporary counter for first element: iCount=1. 1 is used for clarity*/

op_struct.count[iCount]=iCount;

op_struct.plan_id[iCount]=“381 eeab4”;

op_struct.ppo_id[iCount]=“01 BRD_INGATE”;

op_struct.path[iCount]=“OK”;

op_struct.next_ppo_id[iCount]=“02_BENCH_MET_TST”;

op_struct.path_desc[iCount]=“BENCH METER TEST”;

As a further example, a second element of the array contains the following data of a second record 217 for the input file 204:

iCount++/*temporary counter for second element: iCount=2*/;

op_struct.count[iCount]=iCount;

op_struct.plan_id[iCount]=“381 eeab4”;

op_struct.ppo_id[iCount]=“02_BENCH_MET_TST”;

op_struct.path[iCount]=“OK”;

op_struct.next_ppo_id[iCount]=“03_STENCIL_BOT”;

op_struct.path_desc[iCount]=“Stencil Bottomside”;

Notwithstanding the foregoing data structure (i.e., array), it is understood by one skilled in the art that a variety of data structures in variety of programming languages and/or database tables can be conceived and conveniently employed to hold such data.

Furthermore, as is understood by one skilled in the art, the data structure can be statically or dynamically allocated. Additionally, one skilled in the art understands that the data structure is not limited by the foregoing definition and it may hence be modified to hold additional data depending upon the particular requirements for the program embodying the present invention.

The program embodying the present invention then analyzes the data structure (i.e., array of structures) by traversing through successive processing operations in the data structure by utilizing associated decision operations, thereby determining an ordered sequence for the processing operations. The determination of the ordered sequence is performed by a central function called Create_Op_Structure( ), and a subsidiary function called Get_Places_To_Go( ), both of which traverse the foregoing original data structure. The manner in which the central and subsidiary functions traverse the data structure is described in greater detail herein below for the first few records of input file 204 in FIG. 2.

At the outset, the Create_Op_Structure( ) function sets up an exemplary virtual file one dimensional array called “vfile”, and an exemplary virtual file array counter called vfc. For example, a first ordered processing operation in the vfile array (i.e., vfc=1) for FIG. 2 is record 209, and it is represented in the vfile array in the following manner: vfile[vfc]=“01_BRD_INGATE”. As the Create_Op_Structure( ) function traverses the original data structure it updates the vfile array with processing operations in their ordered sequence, and upon completion of the determination of the ordered sequence, the vfile array is written out to a physical file. The Create_Op_Structure( ) also sets up an exemplary variable called from_op, which represents a “from” operation to be used in a main loop to traverse the original data structure. For example, the initial value for from_op=“01_BRD_INGATE”, which is a processing operation of column PPO_ID 210 of FIG. 2. The initial value of the from_op variable will change as the Create_Op_Structure( ) traverses the original data structure. The Create_Op_Structure( ) further sets up a two-dimensional array called “op” and related counter variables, x and y, for accessing the elements of the two dimensional array. The op array will contain records from the original data structure. The two counter variables utilized for indexing into the op array are defined and initialized in the following manner: int x=1, y=0. Consequently, the op array is initialized in the following manner for the two initialized counter variables described above: op[x][y]=op_struct.ppo_id[x] (i.e., “01_BRD_INGATE” for x=1 and y=0). The Create_Op_Structure( ) further sets up a one-dimensional exemplary array for visited places (e.g., visited processing operations) called “vplace”, and an exemplary counter called total_place. The total_place counter is initialized to 1 and the vplace array is initialized in the following manner: vplace[total_place]=op_struct.ppo_id[total_place] (i.e., “01_BRD_INGATE”). Now that all the particular arrays and variable have been setup, the program loops via its main loop through the original data structure, resetting the particular value of from_op at each iteration of the loop and calling the subsidiary function Get_Places_To_Go( ).

The subsidiary function Get_Places_To_Go( ) determines a particular number of processing operations to which the processing operation in the from_op variable can go and not go (e.g., branching). That is, this function determines how many processing operations in op_struct.next_ppo_id described above, to which the current processing operation in the from_op branches. This is done by analyzing in a loop whether op_struct.ppo_id for every element in the original data structure is equal to the from_op variable. If op_struct.ppo_id=from_op, the program stores the processing operations to which the processing operation in the from_op variable braches to, in a one-dimensional array called “nl_op” (i.e., next level operations). To access elements in the nl_op array, the program defines a counter called nlc (i.e., next level counter), which is initialized to 1. The foregoing value of from_op utilized in first iteration of the Get_Places_To_Go( ) function is “01_BRD_INGATE” (See FIG. 2, record 209, PPO_ID 210). Consequently, the next level operation is nl_op[nlc]=op_struct.next_ppo_id (i.e., “02_BENCH_MET_TST” for nlc=1). Furthermore, within this function, a check is performed to determine whether next_ppo_id (i.e., “02_BENCH_MET_TST”) is in the vplace array described hereinabove. Because “02_BENCH_MET_TST” is not in the vplace array, the counter total_place is incremented by one (i.e., total_place=2), wherein vplace[total_place]=“02_BENCH_MET_TST”. Furthermore, a new Boolean array called “followPath” is created for each from_op, to store results of the search through the visited place (i.e., processing operations) in the vplace array. Since “02_BENCH_MET_TST” has not yet been analyzed at this point, followPath[nlc]=true. If the “02_BENCH_MET_TST” processing operation were already in the vplace array the value of followPath[nlc]=false.

Now referring back to the main loop in the Create_Op_Structure( ), each time control returns to the main loop from the subsidiary function Get_Places_To_Go( ), the program performs the following tasks. First the program increments the y variable (e.g., y++). At this point, the program determines how many logical dots (e.g., dot-count-by-row described herein below) to indent each subsequent processing operation under the current from_op variable by setting a variable dot_count. For example, the dot_count variable for “02_BENCH_MET_TST” will be 1, thereby offsetting or indenting this processing operation under “01_BRD_INGATE” by a length of one dot (i.e., described below). Next, the array op is updated in the following manner for x=1, y=1: op[x][y]=nl_op[nlc] (i.e., op[1][1]=“02_BENCH_MET_TST”). Furthermore, a new record comprising a processing operation preceded by the determined dot_count is added to the vfile, and the counter vfc is incremented (i.e., vfc=2). More particularly, the value of vfile[vfc]=“. 02_BENCH_MET_TST”. Thereafter, the from_op variable is updated to the next processing operation from the op array: from_op=op[x][y].

The foregoing processing by the main loop in the central Create_Op_Structure( ) function and the subsidiary function Get_Places_to_go( ) continues until all the processing operations in the vplace array are traversed. Thus, up until “04_PASTE_VISUAL” 218 of FIG. 2, the counter nlc=1 and the dot count is incremented by one for each successive processing operation added to the vfile. The exemplary vfile includes the following data after the first four records of FIG. 2 are traversed:

vfile[1]=“01_BRD_INGATE”

vfile[2]=“. 02_BENCH_MET_TST”

vfile[3]=“.. 03_STENCIL_BOT”

vfile[4]=“... 04_PASTE_VISUAL”

The exemplary op array includes the following data after the first four records of FIG. 2 are traversed:

op[1][0]=“01_BRD_INGATE”

op[1][1]=“02_BENCH_MET_TST”

op[2][0]=“02_BENCH_MET_TST”

op[2][1]=“03_STENCIL_BOT”

op[3][0]=“03_STENCIL_BOT”

op[3][1]=“04_PASTE_VISUAL”

op[4][0]=“04_PASTE_VISUAL”

The vplace array (i.e., for visited processing operations) after four iterations includes the following data:

vplace[1]=“01_BRD_INGATE”

vplace[2]=“02_BENCH_MET₁₃ TST”

vplace[3]=“03_STENCIL_BOT”

vplace[4]=“04_PASTE_VISUAL”

Now reference is made to the main loop in the Create_Op_Structure( ), when control returns to the main loop from the subsidiary function Get_Places_To_Go( ) after the fifth decision operation in column PPO_NEXT_PATH_ID 212 (i.e., fifth record). After the return from Get_Place_To_Go( ) function, the number of paths will be two, which is designated in the following manner: nlc=2. The followPath array includes the following Boolean data:followPath[1]=false and followPath[2]=true. Based on this, there is only one path or branch to follow (i.e., followPath[2]=true) because processing operation “03_STENCIL_BOT” is an element found within the vplace array and the processing operation “05_BOTTOMSIDE” is not. At this point the op array includes the following additional data:

op[4][1]=“03_STENCIL_BOT”

op[4][2]=“05_BOTTOMSIDE”

Subsequently, the doc_count is determined for both of the processing operations and each of the processing operations is stored in the vfile array in the following manner:

vfile[5]=“.... 03_STENCIL_BOT”

vfile[6]=“.... 04_PASTE_VISUAL”

Based on a processing operation that is to followed (i.e., followPath[2]=“03_STENCIL_BOT”) as indicated in the followPath array, the program reorders the vfile array (i.e., elements 5 and 6 indicated above) to according to the processing operation that should be followed, which is stored after the one not to be followed (i.e., “05_BOTTOMSIDE”) . It should be noted that the reordering according to followPath array may also be conveniently performed after all processing operations have been written to the vfile array. Therefore, based on the FollowPath array, the program reorders the two elements in the following manner:

vfile[5]=“.... 04_PASTE_VISUAL”

vfile[6]=“.... 03_STENCIL_BOT”

After the foregoing traversal of the data structure, the program embodying the present invention logically associates a first color (e.g., black) with processing operations that occur only once in the data structure thus analyzed. The program further logically associates a second color (e.g., blue) with processing operations that are associated with two or more decision operations leading to other processing operations, as described herein above. Yet further, the program logically associates a third color (e.g., red) with processing operations that repeatedly occur (i.e., appear more than once) in the data structure. Logically associating color in the aforementioned way is a preferred way of exemplifying an easy-to-follow flow for the multi-nodal process or workflow 200 of FIG. 2. It is contemplated that instead of associating colors with processing operations, one skilled in the art may associate a variety of ASCII characters, such as, “.−+@#*% ( ){}[]” and the like with the foregoing different processing operations. FIG. 3 illustrates an exemplary diagrammatic representation 300 of the multi-nodal process or workflow in FIG. 2 generated in accordance with the present invention. The generation of the diagrammatic representation 300 invokes a process for vertically orientating (i.e., from top to bottom) the processing operations in the determined sequence, while horizontally indenting or offsetting (i.e., from left to right) each successive processing operation, wherein each processing operation associated with two or more decision operations is linked to further processing operations according to the decision operations. For example, by referring to FIGS. 2 and 3, it is clear that node 218 (e.g., “04_PASTE_VISUAL”) is directly located above node 219 (e.g., “03_STENCIL_BOT”) and node 220 (e.g., “05_BOTTOMSIDE”) to both of which node 218 is vertically linked or connected via link 307 in accordance with the aforementioned determined ordered sequence. As particularly illustrated in FIG. 3, the processing operations occurring once are displayed in the associated black color 302, processing operations associated with two or more decision operations leading to further processing operations are displayed in blue color 304, and processing operations repeatedly occurring are displayed in red color 306.

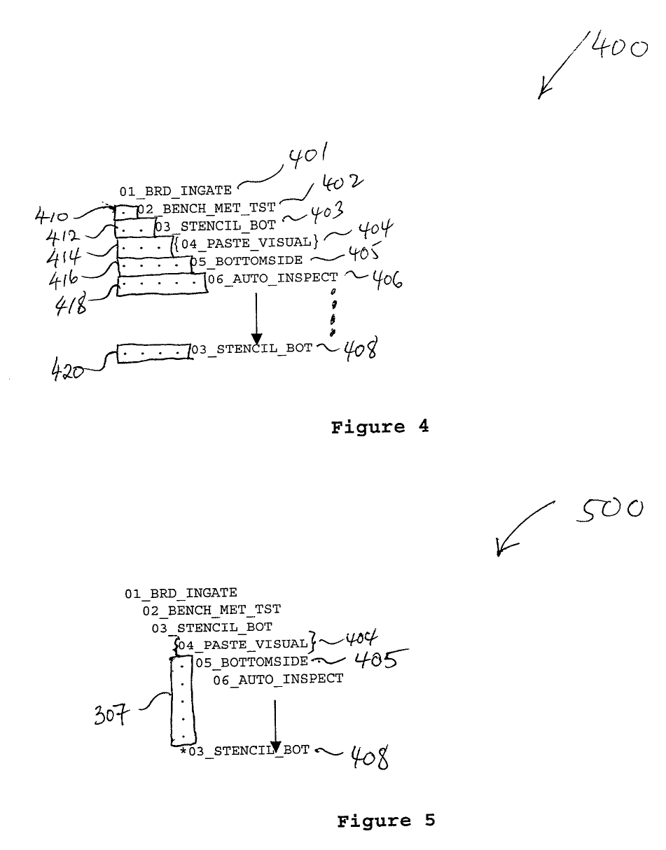

Further referring to FIG. 3, a preferred way for determining the horizontal indentation (e.g., offset) and vertical alignment of the successive processing operations is by using a logical dot-count-by-row construct 410, which is illustrated in FIGS. 4 and 5. In this construct, as illustrated in FIG. 4, each successive processing operation 410 . . . 420 (i.e., successive row) is logically horizontally indented or offset a length of one additional dot for each successive row. Yet further, processing operations to which a link, such as link 307, is defined get the dot count equal to the originating processing operation, such as operation 414. The length for the dot is predetermined, and can be set by to a particular number of characters in length. For example, the length of one dot can be set to two, three or four characters in length, depending on particular horizontal compactness of the desired diagrammatic representation.

Now referring to FIG. 5, once the logical dot-count-by-row is implemented according to FIG. 4 for the routing of the multi-nodal process or workflow 200 as illustrated in FIG. 2, the program iterates through the processing operations according to the determined ordered sequence in the vfile (i.e., described herein above) and retains logical dots for those processing operations (i.e., on successive rows) that lead to two or more other processing operations, while removing logical dots from processing operations that do not lead to two or more other processing operations. With respect to FIG. 5, the retention of necessary dots 307 and removal of other unnecessary dots enables vertical linking and aligning of the processing operation 404 (e.g., “04_PASTE_VISUAL”)—which has two or more associated decision operations—with further processing operations 408 (e.g., “03_STENCIL_BOT”) and 405 (e.g., “05_BOTTOMSIDE”) according to the associated respective decision operation 221 and 222 described herein above with reference to FIG. 2.

According to the present invention, the program is enabled to generate the output diagrammatic representation (i.e., flowchart) illustrated in FIG. 3, in a form suitable for output over a communication network for presentation in a web-enabled browser, such as Netscape Communicator™ or Internet Explorer™. Communication media may include, but are not limited to, a wired or wireless network such as an Intranet and the Internet. In the preferred embodiment, the program generates or writes a markup language (e.g., HTML) file in a conventional manner, wherein the markup language file represents the flowchart of the multi-nodal process or workflow of FIG. 3, as described herein above with reference to FIGS. 3, 4 and 5.

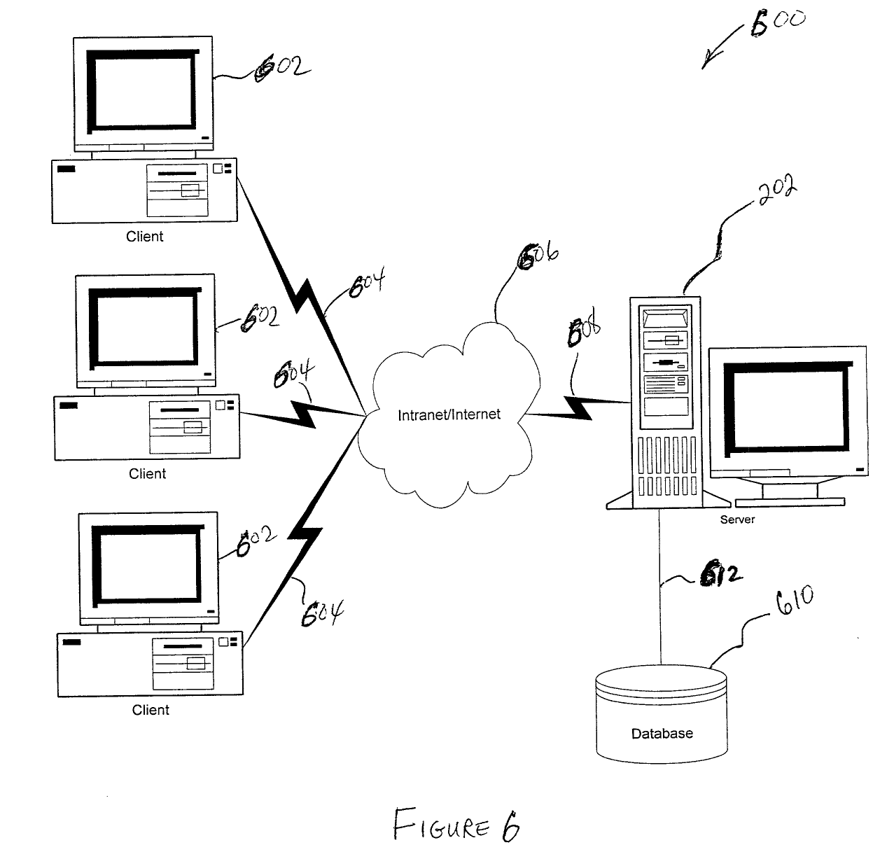

FIG. 6 is an exemplary diagram representing a system 600 in which the present invention can be practiced. The server 202 includes a memory storage device 610 (e.g., a database), which contains data for a particular routing. As is understood by one skilled in the art, the database can be external to the server (i.e., located on another server), and communication to such database can be accomplished via communication link 612, which can be an Intranet or the Internet. The server 202 is interconnected via communication link 608 to an Intranet/Internet 606. A plurality of clients 602 are interconnected to the server 202 via communication links 604. The server 202 stores the input file 204 that contains the input raw data extracted or exported from a database 610, as described herein above with regard to FIG. 2. The program embodying the present invention may be stored on the server 202 and be remotely instantiated by the clients, or the program may be stored at and instantiated at the server by a system administrator. As described herein above, the program is enabled to generate an output markup language file of the diagrammatic representation illustrated in FIG. 3 for presentation over a communication network 604, 606 and 608 in a web-enabled browser at a client 602.

While the present invention has been particularly shown and described with respect to preferred embodiments thereof, it will be understood by those skilled in the art that the foregoing and other changes in form and details may be made therein without departing from the spirit and scope of the present invention.

Having thus described my invention, what I claim as new, and desire to secure by Letters Patent is:

1. An automatic flowcharting method for diagrammatically representing a multi-nodal process comprising processing operations and decision operations, said method comprising:
(a) converting processing operations and decision operations of said multi-nodal process into a data structure;
(b) analyzing said data structure for identifying a first group of processing operations that appear once in said data structure, and for identifying a second group of processing operations that are associated with two or more decision operations in said data structure;
(c) traversing said data structure to generate an ordered sequence of processing operations for visual representation; and
(d) generating a diagrammatic representation of said ordered sequence including orienting successive processing operations in a vertical dimension and associating attributes to each processing operation of said processing operations according to their identified group while offsetting each successive processing operation in a horizontal dimension, and linking each processing operation of said second group to a further processing step of said processing steps according to a decision operation of said two or more decision operations.

2. The automatic flowcharting method according to claim 1, said method further comprising the step of:
associating a first visual attribute to said processing operations in said first selected group and a second visual attribute to said processing operations in said second selected group.

3. The automatic flowcharting method according to claim 2, wherein said first visual attribute is a first color.

4. The automatic flowcharting method according to claim 2, wherein said second visual attribute s a second color.

5. The automatic flowcharting method according to claim 1, said analyzing step further comprising:
identifying a third group of processing operations that repeatedly appear in said data structure.

6. The automatic flowcharting method according to claim 5, said analyzing step further comprising:
associating a third visual attribute to said processing operations in said third group.

7. The automatic flowcharting method according to claim 6, wherein said third visual attribute is a third color.

8. The automatic flowcharting method according to claim 1, said method further comprising a step of:
reading an input file containing said processing operations and said decision operations for said multi-nodal process, said processing operations and said decision operations being arranged into a plurality of records each of said plurality of records containing a first processing operation, a second processing operation and a decision operation.

9. The automatic flowcharting method according to claim 8, said method further comprising a step of:
automatically exporting said processing operations and said decision operations for said multi-nodal process from a database into said input file.

10. The automatic flowcharting method according to claim 1, said analyzing step further comprising a step of:
detecting deadlock conditions in said sequence.

11. The automatic flowcharting method according to claim 1, wherein the linking of each processing operation of said second group includes aligning said processing operation to said further processing step in said vertical dimension.

12. The automatic flowcharting method according to claim 1, wherein said each successive processing operation is offset in said horizontal dimension relative to an immediate prior processing operation.

13. The automatic flowcharting method according to claim 1, said method further comprising a step of:
writing an output file for said generated diagrammatic representation of said multi-nodal process.

14. The automatic flowcharting method according to claim 13, wherein said output file is written in a markup language for presentation in a web-enabled browser.

15. The automatic flowcharting method according to claim 14 wherein said output file is transmitted over a communications network.

16. The automatic flowcharting method according to claim 15 wherein said communications network is one selected from the group comprising:
an Intranet, and
the Internet.

17. An automatic flowcharting system for diagrammatically representing a multi-nodal process comprising processing operations and decision operations in a client-server environment, said system comprising:
(a) a server interconnected via a communications network to a client, said server including:
(i) a mechanism for converting processing operations and decision operations of said multi-nodal process into a data structure;
(ii) a mechanism for analyzing said data structure for identifying a first group of processing operations that appear once in said data structure, and for identifying a second group of processing operations that are associated with two or more decision operations in said data structure; and
(iii) a mechanism for traversing said data structure to generate and ordered sequence of processing operations for visual representation;
(iv) a mechanism for generating a diagrammatic representation of said ordered sequence including orienting said processing operations in a vertical dimension and associating attributes to each processing operation of said processing operations according to their identified group while offsetting each successive processing operation in a horizontal dimension, and linking each processing operation of said second group to a further processing step of said processing steps according to a decision operation of said two or more decision operations;
(b) said client for receiving said generated diagrammatic representation of said multi-nodal process via said communications network in a form for presentation by said client.

18. The automatic flowcharting system according to claim 17, said server further including:
a mechanism for associating a first visual attribute o said processing operations in said first group and a second visual attribute to said processing operations in said second group.

19. The automatic flowcharting system according to claim 18, wherein said first visual attribute is a first color.

20. The automatic flowcharting system according to claim 18, wherein said second visual attribute is a second color.

21. The automatic flowcharting system according to claim 17, said mechanism for analyzing further comprising:
a mechanism for identifying a third group of processing operations that repeatedly appear in said data structure.

22. The automatic flowcharting system according to claim 21, said mechanism for analyzing further comprising:
a mechanism for associating a third visual attribute to said third group of processing operations.

23. The automatic flowcharting system according to claim 22, wherein said third visual attribute is a third color.

24. The automatic flowcharting system according to claim 17, said server further including:
a mechanism for reading an input file containing said processing operations and said decision operations for said multi-nodal process, said processing operations and said decision operations being arranged into a plurality of records each of said plurality of records containing a first processing operation, a second processing operation and a decision operation.

25. The automatic flowcharting system according to claim 24, said server farther including:
a mechanism for automatically exporting said processing operations and said decision operations for said multi-nodal process from a database into said input file.

26. The automatic flowcharting system according to claim 17, said mechanism for analyzing further comprising:
a mechanism for detecting deadlock conditions in said sequence.

27. The automatic flowcharting system according to claim 17, wherein in the mechanism for generating, each processing operation of said second selected group is vertically linked to said further processing step of said processing steps.

28. The automatic flowcharting system according to claim 17, said mechanism for generating further comprising:
a mechanism for determining a horizontal indentation for each successive processing operation of said processing operations.

29. The automatic flowcharting system according to claim 17, said server further including:
a mechanism for writing an output file of said generated diagrammatic representation of said multi-nodal process.

30. The automatic flowcharting system according to claim 28, wherein said output file is written in a markup language for presentation in a web-enabled browser by said client.

31. The automatic flowcharting system according to claim 30, wherein said output file is transmitted over said communications network.

32. The automatic flowcharting method according to claim 31, wherein said communications network is one selected from the group comprising:
an Intranet, and
the Internet.

33. A program storage device readable by a machine, tangibly embodying a program of instructions executable by the machine to perform an automatic flowcharting method for diagrammatically representing a multi-nodal process comprising processing operations and decision operations, said method comprising:
(a) converting processing operations and decision operations of said multi-modal process into a data structure;
(b) analyzing said data structure for identifying a first group of processing operations that appear once in said data structure, and for identifying a second group of processing operations that are associated with two or more decision operations in said data structure; and
(c) traversing said data structure to generate an ordered sequence of processing operations for visual representation;
(d) generating a diagrammatic representation of said ordered sequence including orienting said processing operations of in a vertical dimension and associating attributes to each processing operation of said processing operations according to their identified group while offsetting each successive processing operation of said in a horizontal dimension, and linking each processing operation of said second group to a further processing operation of said processing operations according to a decision operation of said two or more decision operations.

34. The program storage device according to claim 33, said method further comprising the step of:
associating a first visual attribute to said processing operations in said first group and a second visual attribute to said processing operations in said second group.

35. The program storage device according to claim 34, wherein said first visual attribute is a first color.

36. The program storage device according to claim 34, wherein said second visual attribute is a second color.

37. The program storage device according to claim 33, said analyzing step further comprising:
identifying a third group of processing operations that repeatedly appear in said data structure.

38. The program storage device according to claim 37, said analyzing step further comprising:
associating a third visual attribute to said third group of processing operations

39. The program storage device according to claim 38, wherein said third visual attribute is a third color

40. The program storage device according to claim 33, said method further comprising a step of:
reading an input file containing said processing operations and said decision operations for said multi-nodal process, said processing operations and said decision operations being arranged into a plurality of records each of said plurality of records containing a first processing operation, a second processing operation and a decision operation.

41. The program storage device according to claim 40, said method further comprising a step of:
automatically exporting said processing operations and said decision operations for said multi-nodal process from a database into said input file.

42. The program storage device according to claim 33, said analyzing step for determining a sequence further comprising a step of:
detecting deadlock conditions in said sequence.

43. The program storage device according to claim 33, wherein the linking of each processing operation of said second group includes visually aligning said processing operation in said vertical dimension to said further processing step.

44. The program storage device according to claim 33, wherein said each successive processing operation is offset in said horizontal dimension relative to an immediate prior processing operation.

45. The program storage device according to claim 33, said method further comprising a step of:
writing an output file of said generated diagrammatic representation of said multi-nodal process.

46. The program storage device according to claim 45, wherein said output file is written in a markup language for presentation in a web-enabled browser.

47. The program storage device according to claim 46, wherein said output file is transmitted over a communications network.

48. The program storage device according to claim 47, wherein said communications network is one selected from the group comprising:
an Intranet, and
the Internet.
